(19) United States
(12) Patent Application Publication
(10) Pub. No.: US 2012/0272570 A1
(43) Pub. Date: Nov. 1, 2012

(54) PLANT GROWING AND DISTRIBUTION SYSTEMS

(76) Inventor: Steven E. Rinehart, Encinitas, CA (US)

(21) Appl. No.: 13/456,453

(22) Filed: Apr. 26, 2012

Related U.S. Application Data
(60) Provisional application No. 61/479,066, filed on Apr. 26, 2011.
(60) Provisional application No. 61/479,013, filed on Apr. 26, 2011.

(51) Int. Cl. A01C 14/00

(52) U.S. Cl. 47/58.1 R

(57) ABSTRACT

Methods of transporting or causing transport of a plant or plant part between two locations are provided. For example, plants or plant parts are placed in a support substrate that is free of organic soil, peat, humus or bark at a first location and transported to a second location. Methods for growing plants are also provided comprising, for example, receiving a transported plant or plant part embedded in a support substrate that is essentially free of organic soil, peat or bark and growing a plant therefrom.

This application claims the benefit of U.S. Provisional Patent Application Nos. 61/479,066, filed Apr. 26, 2011, the entirety of which is incorporated herein by reference.

This application is related to U.S. Provisional Patent Application No. 61/479,013, filed Apr. 26, 2011, the entirety of which is incorporated herein by reference.

### BACKGROUND OF THE INVENTION

1. Field of the Invention

The present embodiments provided herein relate generally to horticultural and agricultural business and commerce.

2. Description of Related Art

Plants are high value commodity products not only for food production but also as sources of landscaping and ornamental decoration. However, give the difficulty and time involved in growing plants from seed, already growing plants are often preferred to seed. Likewise, certain plant species produce little seed and/or only rarely produce seed and are therefore vegetatively propagated. However, initial growth of plants either from seed or from cuttings is labor intensive and thus expensive. There is a need therefore for methods to provide plants to the market with reduced production costs.

### SUMMARY OF THE INVENTION

In a first embodiment there is provided a method for transporting or causing to transport a plant from a first location to a second location, the method comprising (a) placing, at a first location, a plant in a plant support substrate that is essentially free from organic soil, peat, humus, coir and/or bark, to form an embedded plant; and (b) transporting or causing to transport said embedded plant to said second location. For example, the embedded plants can be transported by a third party under a contract or service agreement. The method of transport will generally be determined by the distance of transport, the time required and the cost. For example, embedded plant can be transported or caused to be transported by ship, train, truck, car or airplane. In still further aspects, transporting or causing transport of an embedded plant comprises providing an environment suitable to maintain health of the embedded plant during transport. For example, the environment can have a regulated level of moisture (e.g., humidity), regulated temperature and/or regulated lighting conditions to maintain plant health. In certain aspects, an embedded plant is wrapped in a water impermeable material prior to transporting.

In certain aspects a method according to the embodiments comprises placing a plant (or plant part) in a plant support substrate. As used herein the plant can be, for example, a plant cutting, a seedling or an in vitro plant culture. Thus, a plant is placed in the substrate such that the matrix can provide water, air and nutrients to the plant to allow plant growth and/or survival. For example, a plant can be positioned in a cavity in a substrate, such that the plant is in contact with the substrate (e.g., a portion of a plant or cutting can be embedded in the matrix). In another example, a support substrate can be in the form of plug that hat has been completely or partially cut, such that the plant can be positioned in the space between the cut portions of substrate (e.g., the substrate is folded around the plant).

In further aspects, a method according to the embodiments comprises a step of generating callus tissue on a plant prior to placing a plant in a plant support substrate. For example, the plant can be grown in a first growth medium under conditions sufficient to generate callus tissue (e.g., controlled humidity, temperature and lighting conditions). The first growth medium can be any medium which support callus tissue growth such as an organic, synthetic or partially synthetic medium.

In yet further aspects, a method in accordance with the embodiments comprises a step for washing a plant (e.g., a callused plant) prior to placing a plant in a plant support substrate. In some cases, the washing comprises removing non-plant organic material from the plant (e.g., organic soil components). For example, a washing step can comprise rinsing in a solution and/or mechanically scrubbing the plant. In certain aspects, a washing solution comprises detergents, sterilizing agents (e.g., bleach), antifungal agents, antibacterial agents and/or pesticides.

In a second embodiment, the invention provides a method for growing a plant, the method comprising (a) receiving a plant in a second location, wherein the plant has been transported from a first location and further wherein the plant, as received, is comprising in a plant support substrate that is essentially free from organic soil, peat, humus and/or bark; and (b) growing the plant so received. For example, growing a plant so received can comprise allowing the plant to increase in height, number of leaves, number of buds or flowers and/or can comprise allowing mature root tissue to form. In certain aspects, such a method further comprises the step of transferring the plant or the embedded plant to a further growth medium. For example, the further growth medium can be a synthetic medium, a partially synthetic medium or a medium comprising organic soil, peat, humus and/or bark. Transferring of a plant or embedded plant in accordance with the embodiments can be before or after growing of the plant. Thus, in certain aspects, a plant is grown in a plant support substrate (e.g., a substrate used for transport) before the a transferring step.

Plants or embedded plants can be transferred to a further growth medium by a variety of methods. For example, the plants can be manually transferred to the further growth medium. In certain cases, transferring of a plant (or an embedded plant) can be automated, such as by the use of a robotic transplanting machine. A robotic transplanting machine can, for instance be a computer controlled machine. Robotic machines for transplanting plants have been described for example in U.S. Patent Publn. Nos. 20040020110 and 20120005955 and in Dutch Patent Appln. No. NL-2004951, filed Jun. 23, 2010, each of which is incorporated herein by reference. In yet a further aspect, a method according to the embodiment comprises a step of distributing or causing distribution of a plant to at the second location. For example, distributing or causing distribution can comprise receiving a payment or compensation for the plant.

Certain aspects of the embodiments concern a plant support substrate that is essentially free from organic soil, peat, humus, coir and/or bark. For example the plant support substrate can be a sponge-like matrix that is porous, retains water and comprises admixture of a hydrophilic polymer (e.g., polyurethane) and amorphous silica. Plant support substrates that can be used in accordance with the embodiments are described, for instance, in co-pending Provisional U.S. Patent Appln. No. 61/479,013, entitled “Soil Free Planting Composition”, filed on Apr. 26, 2011, which is incorporated herein by reference in its entirety.

In further aspects, methods according to the embodiments concern plants that are transported from a first location to a second location. The first location and the second location can, for example, be a first and second country, respectively. For instance, the second country can be the United States and the first country, a country other than the United States, such as a country in Europe, Africa, Asia, the middle east, South America or central America (e.g., Mexico, Guatemala, Belize, Honduras, Nicaragua, Costa Rica, Panama or Columbia). In some aspects, the first location has a lower average cost of labor relative to the second location (e.g., a cost of labor that is less than 50% that of the second location, such as a labor cost about 30%, 20%, 10%, 5%, 3%, or 1% less than that of the second location).

In yet further aspects, a method according to the invention concerns plant support substrate and/or a plant embedded in a plant support substrate. A plant support substrate can be provided in wide array of forms such as, for example, a cup, pot or plug shape. In certain aspects, the plant support substrate is provided as plug comprising a centrally disposed cavity (e.g., a hole, which extends through all or a portion of the plug). In further aspects, a substrate plug can be partially or completely cut in half (e.g., such that the two portions of the plug can be used to wrap a plant or portion of a plant). Such a plug can be formed into virtually any size, such as, for example, a plug having a diameter of between about 0.25 to 5 inches and a height of between about 0.5 to 12 inches. Example plug shapes and dimensions are provided, for instance, in U.S. Pat. No. 6,901,699, incorporated herein by reference.

In still further aspects, a method according to the embodiments involves placing a plant. Thus, in certain cases, the method comprises placing a plurality of plants in a plurality of plant support substrates to form a plurality of embedded plants. Likewise, a method can, in some aspects, comprise transporting or causing to transport a plurality of embedded plants to said second location. Likewise, certain aspects of the embodiments can comprise receiving plurality of embedded plants and/or growing a plurality of plants so received.

In yet further aspects of the embodiments, a plurality of individual pieces of plant support substrates (e.g., plugs) and/or embedded plants are arrayed in cells. In certain cases, cells comprising the plugs are further arrayed in a strip or on a tray. Thus, in certain aspects, a method according to the embodiments comprises transporting or causing to transport of one or more strips or trays comprising a plurality (e.g., between about 5, 10, 20 and 100) embedded plants. Trays and strips comprising plant support substrates and/or embedded plants, in certain aspects, are configured to allow the plants or substrate material to be easily removed after transport. For example, such tray or strips can be configured for use with a robotic transplanting machine. Trays and strips comprising a false bottom that may used according to the embodiments are described, for instance, in U.S. Patent Publn. No. 20100180500, incorporated by reference. Automated methods for providing an array of embedded plants and/or substrates on a tray or strip are also available and can be implemented with the methods of the embodiments (see, e.g., U.S. Patent Publn. No. 20040086361, incorporated herein by reference). Trays and strips for use according to the embodiments can be composed of any convenient material such as a plastic or a biodegradable material such as a starch-based material.

As used herein the term plant refers to any plant or plant part that can be grown into a mature plant, such as a seeding or in vitro plant culture. Thus, in certain aspects, the plant is plant part such as a cutting (e.g., a callused cutting) of a stem, leaf or bud that can be grown into a mature plant. A plant cutting can, in some cases, comprise root tissue. In certain aspects, however, a plant cutting is essentially free of root tissue and can thereby be transplanted from a plant support substrate with minimal damage to the plant.

A plants for used according to embodiments of the invention can be dicot or monocot plants. In certain aspects, the plants are varieties that can be vegetatively propagated. In further aspects, the plant is an ornamental plant, a landscaping plant, an herb, a garden vegetable or a fruit or nut tree. For example, the plant can be an agastache, angelonia, antirrhinum, argyrantheum, bacopa, begonia, bidens, calibrachoa, coleus, crossandra, impatient, diascia, fuchsia, gaura, gazania, geranium, helichrysum, ipomoea, kalanchoe, lamium, lantana, lavender, lobelia, nemesia, daisy, fan flower, oxalis, petunia, hibiscus, poinsettia, salvia, torenia, verbena, or viola plant.

The use of the word “a” or “an” when used in conjunction with the term “comprising” in the claims and/or the specification may mean “one,” but it is also consistent with the meaning of “one or more,” “at least one,” and “one or more than one.”

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference the drawings in combination with the detailed description of specific embodiments presented herein.

FIG. 1: An schematic showing an example of a method according to embodiments occurring at a first location.

FIG. 2: An schematic showing an example of a method according to embodiments occurring at a second location.

### DESCRIPTION OF ILLUSTRATIVE EMBODIMENTS

Production of living plants as commodity products is currently hampered by the high production cost of such plants. However, problems encountered in importing the plants do not allow foreign labor markets to be fully utilized for production. For example, U.S. import regulations limit the types of material in which imported plants can be maintained. Furthermore, significant product loss can occur, due to inadequate water and nutrient supply provided to the plants in transport. New horticultural business methods are therefore needed to address these issues and reduce plant production costs.

It has now been demonstrated that plant support substrates, substantially free from organics, such as soil, peat, humus and coir can be used for transport of plants. The support substrates met U.S. customs requirements for import and therefore allow import of foreign grown plants in mass. Moreover, the substrates and transport methods are able to maintain plant health during transportation to reduce product loss. Thus, there are now provided new methods for transporting plants by positioning the plants in a support substrate free from undefined organic components and transporting (or causing to transport) the embedded plants. Likewise, methods for importing such plants are provided comprising receiving the embedded plants and growing them for end users. These new methods allows plants to be initially prepared in countries where manual labor costs are low and efficiently imported into the U.S. Once in the U.S. the plants can be moved to organic (e.g., soil)-based growth media by automated processes. Thus, the methods detailed herein allow a significant shifting of manual labor in plant production, abroad, thereby reducing production costs. The reduced production cost benefit both end users and the horticulture industry, by reducing product cost and enhancing profits, respectively.

Additional aspects to the plant support substrates are detailed below.

### I. Exemplary Processes According to the Embodiments

Plant Production and Export

Plants are initially produced at first location to take advantage of lower labor costs and/or local environmental conditions that favor plant production. For example, in the case of tropical plants initial production can take place in a tropical country. The choice of production location can also depend on the growing season for the desired plant. For example, plants can be produced in the southern hemisphere to be provided in the “off season” at a location in the northern hemisphere. Preferably, production occurs at a location with low manual labor costs thereby reducing production cost for the plants.

Plants can be produced by generating cuttings form a mature plant. Alternatively, plants can be grown from seed or in vitro from cell or callus cultures. The plants are placed in a first medium for initial root tissue (i.e., callus) formation. Environmental conditions are controlled to favor callus formation. For example, the plants are kept in consistent lighting and temperature conditions and humidity is maintained by misting of the plants. Likewise, this first medium provides nutrients that are required by the plant and may additionally include agents that that favor callus formation (e.g., plant rooting hormones).

Once initial callus formation has occurred the plants are washed to remove non-plant organic material. In particular, the callus or initial root tissue is washed to removed any soil components from the medium used for callusing. Depending on the amount of root formation that is allowed to occur the stringency of the washing conditions can be varied. For example, while a rinsing may be sufficient for plants with a simple callus, more mature rooted plants may require mechanical scrubbing of the root tissue. In either case, washing solutions can include antimicrobial or sterilizing agents to further reduce the possibility of transfer of contaminating organisms or chemicals to the substrate used for transport.

Once washed the plants are positions into support substrates for transport. The substrates are free of undefined organic material such as hummus, bark, soil, coir and peat. For example, the substrate can be a hydrophilic polyurethane matrix formed in the shape a cylindrical plug. The plug is partially split by a cut that bisects the length (or part of the length) of the plug. The substrate is wetted with clean water and the callus tissue of the plant is positioned into the plug by folding the cut portion of the plug around the callus tissue. In this way, the callus (or root) is in direct contact with the support substrate which can provide moisture and nutrients to the embedded plant. The consistent level of moisture provided by the substrate thereby reduces or prevents leaf yellowing and maintain plant health during the transport process.

Plugs along with their embedded plants are then packaged for transport. The plugs are placed into individual cell in a strip of containment material, such as a petroleum or starch-based polymer. Strips of, for example, 10 or more cells, each comprising an embedded plant can be arrayed. Strips of cells are then arrayed side-by-side on tray to produce a grid of embedded plants. The entire tray can then be wrapped or otherwise packaged to prevent excessive moisture loss. For example, the trays can be wrapped with a plastic or paraffin film. Trays are stacked into crates and loaded for shipment by a selected transport vehicle.

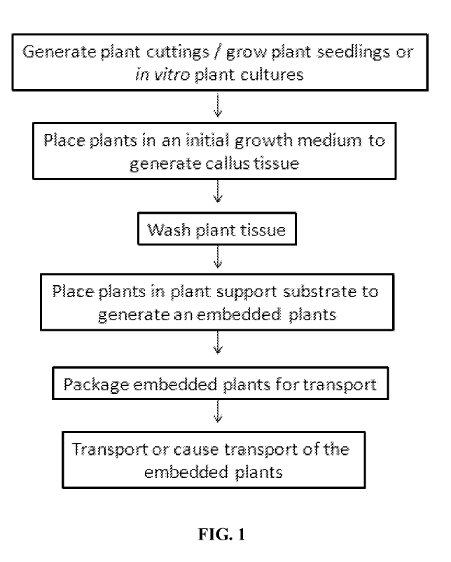

A flow chart showing the steps of an example plant production and export method is shown in FIG. 1.

Plant Import and Growth

Shipping containers that comprise packed embedded plants arrive and are received at the second location such as a location in the United States. In case of import to the U.S., the shipment must pass inspection at a U.S. Department of Agriculture Animal and Plant Health Inspection Service (APHIS) facility. The fresh packaging of the plants in a substrate which is free of organics such soil, peat, coir, bark and humus meets with import requirement and thereby allows the plants to pass inspection. Likewise, the controlled moisture environment prevents aberrant fungal growth that could result in a quarantine of the imported plants.

The embedded plants are then transported to a local growing and processing facility. Here, shipping crates are off-loaded and the trays of embedded plants are unpacked. The trays are unwrapped and provided with water and light. Plants may be grown directly in these support substrates for extended periods of time if desired. Typically, however, plants are transplanted in the pots to facilitate further plant growth and rooting.

In order to transplant the embedded plants whole trays or strips of cells can be processed in bulk with an automated machine. Alternatively, individual plants (i.e., in their containment cells) can be cut away from the strips and manually transplanted into a new growth medium. In the case of an automated process, trays or strips of the embedded plants are placed on conveyer belt and moved to the processing location. Here a griper arm removes the embedded plants (and support substrate) from each cells and moves it a new growth medium in a new container.

Once in the new growth medium the plants are provided with water, nutrients and light and are allowed to grow to the desired size and maturity level. For example, the plants can be grown until they reach a flowering stage. At the desired size the plants are shipped to retail locations or directly to end users.

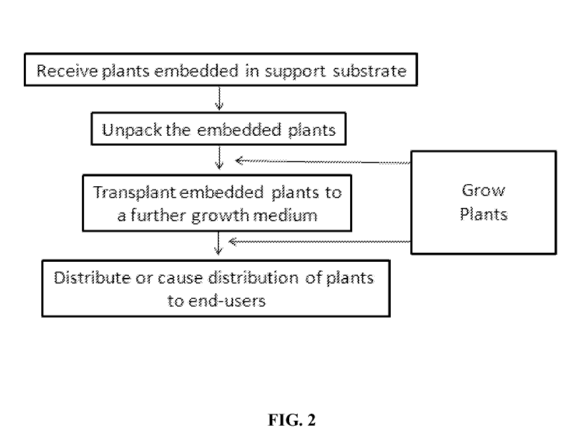

A flow chart showing the steps of an example plant import/growth method is shown in FIG. 2.

### II. Plants for Use in the Embodiments

A wide range of plants can be maintained in the support substrates according to the invention. For example, bedding plants, flowers, ornamentals, vegetables and other container stock can be provided in the substrates. Plants or cuttings of plants may be rooted in the matrix or may remain un-rooted. In certain aspects the plants or cuttings are callused.

Substrates can comprise vegetable crops or a living portions thereof such as artichokes, kohlrabi, arugula, leeks, asparagus, lentils, beans, lettuce, beets, bok Choy, malanga, broccoli, melons (e.g., muskmelon, watermelon, crenshaw, honeydew, cantaloupe), brussels sprouts, cabbage, cardoni, carrots, napa, cauliflower, okra, onions, celery, parsley, chick peas, parsnips, chicory, peas, chinese cabbage, peppers, collards, potatoes, cucumber, pumpkins, cucurbits, radishes, dry bulb onions, rutabaga, eggplant, salsify, escarole, shallots, endive, soybean, garlic, spinach, green onions, squash, greens, sugar beets, sweet potatoes, turnip, swiss chard, horseradish, tomatoes, kale, turnips, and a variety of herbs.

Likewise, fruit and/r vine crops can be provided such as apples, apricots, cherries, nectarines, peaches, pears, plums, prunes, quince almonds, chestnuts, filberts, pecans, pistachios, walnuts, citrus, blackberries, blueberries, boysenberries, cranberries, currants, loganberries, raspberries, strawberries, grapes, avocados, bananas, kiwi, persimmons, pomegranate, pineapple, and other tropical fruits.

In certain preferred aspects, plant ornamental plants (or living portions thereof) are provided in substrate according to the inventions. For example, a matrix can comprise a plant such as an agastache, angelonia, antirrhinum, argyrantheum, bacopa, begonia, bidens, calibrachoa, coleus, crossandra, impatient, diascia, fuchsia, gaura, gazania, geranium, helichrysum, ipomoea, kalanchoe, lamium, lantana, lavender, lobelia, nemesia, scaevola, oxalis, petunia, hibiscus, poinsettia, salvia, torenia, verbena, or viola plant.

### EXAMPLES

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Production and Export of Plants

Ornamental plants, such a poinsettias, are growth in fields or green houses in central America. To prepare commodity plants, cuttings from the mature plants are prepared such that each cutting is capable of regenerating a mature plant. The cuttings are positioned in a first growth medium, such as a soil or synthetic medium, for callusing. Conditions are optimized for callus formation by regulation of temperature and humidity conditions. Plants can be maintained in this initial medium until callus tissue has formed or even until initial root formation begins. Once callus tissue has formed, the plants are removed from the first medium and washed to remove any residual medium or other undesirable organic material.

Plant support substrates, which are free of organic components such as humus, soil, bark and peat, are prepared by laterally splitting substrate plugs and hydrating the plugs with clean water. Each washed plant is positioned in the plant support substrate such that the callus or root tissue extended into the substrate plug. The split plugs are folded around the plant cuttings so as to embed a portion of each cutting in the plug. By positioning the cutting in direct contact with the substrate, necessary nutrients and moisture are provided. Hydration of substrates ad plants is provided through-out the process as needed.

After embedding of the cuttings, plugs are positioned into cells that hold each embedded cutting. Cells are arrayed in strips and the strips are further arrayed onto trays. Once a complete tray has been loaded the tray is wrapped in a water impermeable material to prevent desiccation of the embedded cuttings. The trays can then be further stacked at high density into shipping containers for transport to the United States. Depending the shipment time required the embedded plants are loaded on to a truck or airplane for transit.

A flow chart showing the steps of an example plant export method is shown in FIG. 1.

### Example 2

### Import of Plant Cuttings

Shipping containers arrive the U.S. and are processed at Animal and Plant Health Inspection Service (APHIS) facility. For example, the shipment can be shepherded through the inspection process by a shipping entity (e.g., UPS) that is contracted for such purpose. Once clearing inspection the embedded plants are transported to growing facilities.

Shipping containers are off-loaded and the trays of embedded plants unpacked. Embedded cuttings can be grown directly in the support substrates used for transport or can be moved into a new medium for growth. In either case, the embedded plants are provided with adequate water nutrient and lighting conditions to support growth and further root development.

Embedded plants are typically moved to a new medium prior to being distributed to consumers. While the plants can be transplanted by hand, in large-scale operations an automated system is employed. In this case, trays including the embedded plants are arranged on a conveyor that is fed to a robotic transplanting machine. Embedded plants are removed from the cells by a robotic gripper arm and positioned into a growth medium bed of a new container. The plant support substrates used for transport need not be removed during this process as the continued presence of the substrate will not hamper further plant growth. Once transplanted to the new medium plants can be allowed to grow and further rooting can take place. Once grown to the desired size and maturity product plants are again packaged and shipped for sale to consumers.

A flow chart showing the steps of an example plant import/growth method is shown in FIG. 2.

### REFERENCES

The following references, to the extent that they provide exemplary procedural or other details supplementary to those set forth herein, are specifically incorporated herein by reference.
U.S. Pat. No. 6,901,699
U.S. Pat. Publn. 2004/0020110
U.S. Pat. Publn. 2004/0086361
U.S. Pat. Publn. 2010/0180500
U.S. Pat. Publn. 2012/0005955
Provisional U.S. Pat. Appln. 61/479,013
Dutch Pat. Appln. NL-2004951

1. A method for transporting or causing to transport a plant from a first location to a second location, the method comprising the steps of:
(a) placing, at a first location, a plant in a plant support substrate that is essentially free from organic soil, peat, humus and bark, to form an embedded plant; and
(b) transporting or causing to transport said embedded plant to said second location.

2. The method of claim 1, wherein said first location is in a first country and said second location is in a second country.

3. The method of claim 2, wherein said first country is a country other than the United States and said second country is the United States.

4. The method of claim 1, wherein the first location has a lower average labor cost than the second location.

5. The method of claim 1, wherein the plant is grown in a first medium to generate callus tissue before said placing.

6. The method of claim 1, wherein the plant is washed to remove non-plant organic matter before said placing.

7. The method of claim 1, wherein the embedded plant is wrapped in a water impermeable material prior to said transporting or causing to transport.

8. The method of claim 1, wherein the plant support substrate is in the form of a plug.

9. The method of claim 1, wherein placing a plant comprises placing a plurality of plants to form a plurality of embedded plants.

10. The method of claim 9, wherein transporting or causing to transport said embedded plant to said second location comprises transporting or causing to transport a plurality of embedded plants.

11. The method of claim 1, wherein said transporting or causing to transport is by cargo ship or airplane.

12. The method of claim 1, wherein the plant is a plant cutting, a seedling or an in vitro plant culture.

13. The method of claim 12, wherein the plant is a plant cutting that has been callused.

14. The method of claim 1, wherein the plant cutting is essentially free of mature root tissue.

15. The method of claim 1, wherein the plant is a dicot.

16. The method of claim 1, wherein the plant is an ornamental plant, a landscaping plant, an herb, a garden vegetable or a fruit or nut tree.

17. The method of claim 1, wherein the plant is a plant capable of vegetative propagation.

18. The method of claim 1, wherein the plant is a an agastache, angelonia, antirrhinum, argyrantheum, bacopa, begonia, bidens, calibrachoa, coleus, crossandra, impatient, diascia, fuchsia, gaura, gazania, geranium, helichrysum, ipomoea, kalanchoe, lamium, lantana, lavender, lobelia, nemesia, scaevola, oxalis, petunia, hibiscus, poinsettia, salvia, torenia, verbena, or viola plant.

19. A method for growing a plant, the method comprising the steps of:
a) receiving a plant in a second location, wherein the plant has been transported from a first location and further wherein the plant, as received, is comprising in a plant support substrate that is essentially free from organic soil, peat, humus and bark; and
b) growing the plant so received.

20. The method of claim 19, wherein said first location is in a first country and said second location is in a second country.

21.-36. (canceled)
